(19) United States
(12) Patent Application Publication
(10) Pub. No.: US 2006/0220571 A1
(43) Pub. Date: Oct. 5, 2006

(54) Light emitting diode current control method and system

(75) Inventors: Wayne Howell, Harrow Weald (GB); Simon Hobday, Coulsdon (GB); Allan Bradford, Teighmouth (GB); Adam Pulley, Oxted (GB); Cristoffer Kvist, Orlando, FL (US); Stephen M. Faber, Orlando, FL (US); Brett Kingstone, Orlando, FL (US)

Correspondence Address: AKERMAN SENTERFITT, P.O. BOX 3188, WEST PALM BEACH, FL, 33402-3188, US

(73) Assignee: Super Vision International, Inc., Orlando, FL (US)

(21) Appl. No.: 11/286,864

(22) Filed: Nov. 23, 2005

Related U.S. Application Data
(63) Continuation of application No. 11/096,644, filed on Mar. 31, 2005, now abandoned.

(51) Int. Cl. H05B 37/00

(52) U.S. Cl. 315/86; 315/291

(57) ABSTRACT

A method of accurately controlling at least one of an intensity, brightness, dimming or color mixing of a LED, the method comprising monitoring an actual current flowing through the LED, selecting a specific current based on at least one of a desired illumination intensity, a desired brightness, a desired dimming, or a desired color mixing, comparing said actual current and said specific current, and if a difference exists between said actual current and said specific current, adjusting said actual current to agree with said specific current.

### BACKGROUND OF THE INVENTION

The present invention relates to a lighting system, and more particularly to a light emitting diode (LED) lighting system and method where illuminated intensity of the LED is controlled by varying current applied to the LED.

There are a number of techniques that can be used to control illumination intensity of an LED. One such technique is to vary the voltage that flows across the LED, otherwise known as amplitude modulation. This is accomplished with a current limiting resistor positioned in the circuit. As the voltage is increased, the LED will start to illuminate when the voltage exceeds a forward conduction voltage of the LED. Increased voltage will then increase the intensity of the LED. One drawback with amplitude modulation is that there is a time interval during which the LED does not illuminate because the voltage is at a low end of the voltage range, below the forward conduction voltage. Another drawback is that typically there is no assurance that two identical LEDs, even though produced by the same manufacturer, will provide the same output of light for a given voltage since the manufacturing tolerance of a specific LED provides for a wide range of variation in the forward conduction voltage of each LED produced.

Another technique for controlling illuminating intensity is Pulse Width Modulation (PWM). PWM uses a fixed frequency signal with a repeating drive pulse where the intensity of each LED color is controlled by the width of the pulse. Several known drawbacks exist. One drawback is that unwanted flicker occurs if the modulation frequency is too low. The response of control input to LED current is largely linear. Realizing that LEDs are non-linear devices, a linear intensity response is not produced. Since PWM is a fixed frequency system, all LEDs switch on at the same time in a cycle, but in large systems this can lead to asymmetric loading of the power source and can complicate electromagnetic compliance issues.

Because there typically is a wide range of manufacturing tolerances in LEDs, LED system designers and users of LED systems would benefit from an illumination control system for use with LEDs that results in a more consistent and uniform performance of individual LEDs, especially when the life expectancy of the each LED is not greatly degraded as a result of increasing and decreasing illumination of each LED, and where Pulse Amplitude Modulation is not required.

### BRIEF SUMMARY OF THE INVENTION

To this end, a method and system are disclosed for more effectively controlling intensity, brightness, dimming and/or color mixing of a LED or plurality of LEDs. One such method disclosed includes monitoring an actual current flowing through an LED. A specific current is identified based on a specific intensity, brightness, dimming, and/or color mixing of the LED. The actual current and specific current are compared. If a difference exists between the actual current and the specific current, the actual current is adjusted to agree with the specific current.

A light emitting diode system for controlling at least one of an intensity, brightness, dimming or color mixing of the LED is also disclosed. The system has a control system that includes a microprocessor arranged to control a current value of the LED by comparing an actual current value with a desired current value and establishing a new actual current value.

A dynamic power management system for a point source LED having three or more colored LED sources wherein an LED manufacturing process requires that a maximum allowed current through each LED be dependent upon a total current supplied to all LED sources is also disclosed. This system has a microprocessor to analyze a total drive current to all LED sources where this information, in an exemplary embodiment as part of a feedback loop, is used to modify drive current to each individual LED such that a total power dissipation of the LED sources is not exceeded.

### BRIEF DESCRIPTION OF THE DRAWINGS

The figures shown depict only a sample of configurations that may be employed for the present invention. Those skilled in the art will recognize variations to the figures presented herein. The features and advantages of the present invention will become apparent from the following detailed description of the invention when read with the accompanying drawings in which:

FIG. 1 is an exemplary embodiment of a flow chart illustrating a method of the present invention;

FIG. 2 is an exemplary embodiment of a block diagram illustrating exemplary elements of the present invention;

FIG. 3 is an exemplary embodiment of an electrical schematic illustrating a circuit for controlling current through several LEDs in series based on the present invention; and

FIG. 4 is an exemplary embodiment of an electrical schematic illustrating a standard micro power voltage regular used to produce an analog current control based on the present invention.

### DETAILED DESCRIPTION OF THE INVENTION

Before proceeding to a detailed description of preferred embodiments of the present invention and alternate embodiment, several general comments should be made about the applicability and the scope of the present invention. The present invention can be implemented through hardware and/or software. Though several illustrations discuss the present invention being used with multiple LEDs and in some illustrations a single LED, the present invention can also be used with either a single LED as well as multiple LEDs. Likewise, though some elements are identified as either singular or as a plurality, the reverse of each identification is also possible.

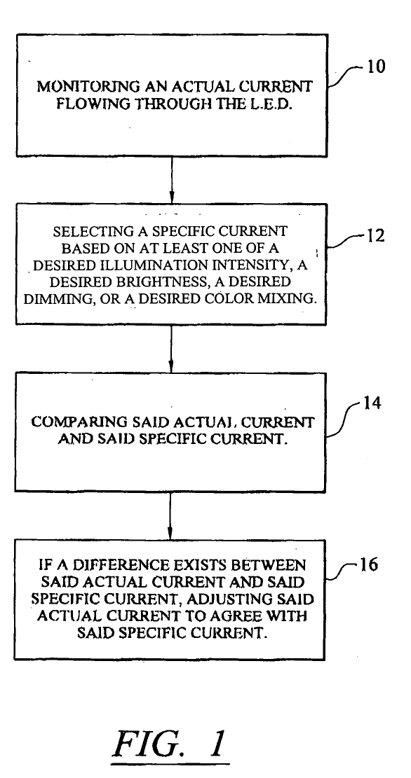

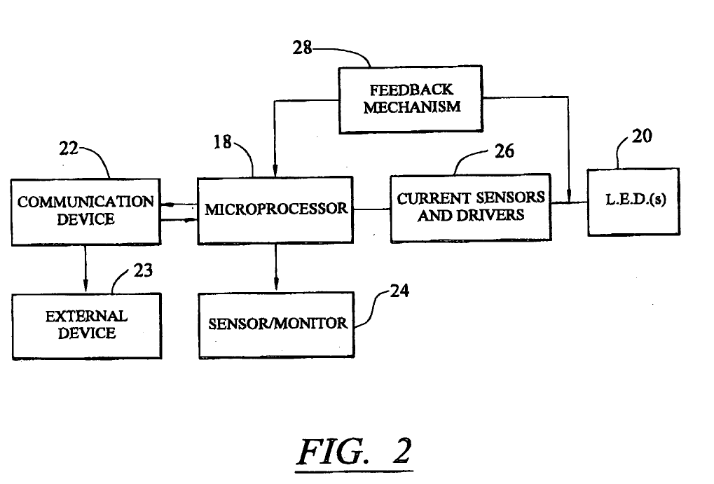

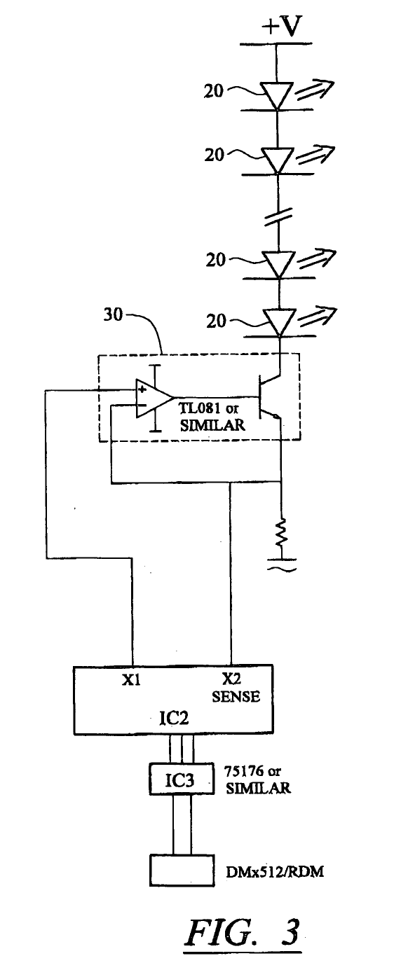

Referring initially to FIGS. 1 and 2, a system and procedure for controlling illumination intensity in an LED are illustrated. FIG. 1 is an exemplary embodiment of a flow chart illustrating a method of the present invention. As illustrated, an actual current level is monitored across an LED 20 at step 10. The measurement, for example, can be accomplished by monitoring the voltage, such as across a sensor resistor. A preselected current level is established based on a desired illumination intensity, brightness, dimming and/or color mixing, step 12, wherein the current level may be based on manufacturer's specifications. The actual current is compared with the specific current value, step 14. This can be accomplished with a feedback mechanism, as illustrated in FIG. 3. As illustrated, the feedback mechanism 28 can ensure that causes that the intensity of the LED 20 matches with the desired intensity of the LED 20.

In a preferred embodiment, a software controlled successive approximation system is used that includes a microprocessor 18 where the microprocessor 18 sets an activation signal for a semiconductor device that controls the current though the LED 20 and then measures the actual current flowing through the LED 20, as further illustrated in FIG. 3. If a difference between the actual and the desired current is determined, the microprocessor 18 adjusts the activation signal until the actual and desired (or pre-selected) current levels are the same, step 16. By applying this method, issues regarding cable length and resistance value of cables are negated while insuring that LEDs 20 are driven within each LED's respective design parameters which may result in improved longevity and uniform luminance.

FIG. 2 is an exemplary embodiment of a block diagram illustrating exemplary elements of the present invention. As illustrated, a processor, such as a microprocessor 18, is provided. As discussed throughout, the microprocessor 18, may be is used in a plurality of ways to determine a desired current for the LED 20 where it may include memory storage to store collected data and/or data, such as manufacturer's data, provided by a user. As those skilled in the art will readily recognize, the microprocessor 18 can perform both hardware and software functions necessary to implement the present invention.

A communication device 22 is also provided and provides bi-directional data connection between the microprocessor 18 and one or more external devices and/or controllers 23. An exemplary example of bi-directional data connection is Remote Device Management (RDM) over a DMX512 cable, preferably occurring on a twisted pair connected to pins 2 and 3 where the same pair of wire can be used to transmit data from the processor to an external controller 23. The communication interface can encompass any system that passes instructions between the microprocessor 18 and the external device 23.

The external device can be used to control the functionality of the present invention and provide data to the microprocessor 18. For example manufacturer data that is specific to the LED 18 can be retained in the external device 23 and then communicated to the microprocessor 18. The external device 23 could also be provided data from the microprocessor or sensor(s) 24 (wherein the external device then determines an operation to relay back to the microprocessor based on the data). In other embodiments of the communication device 22, the device 22 may have a transmitter, receiver or both to facilitate communication using a plurality of techniques, such as but not limited to radio frequency, infrared, and electromagnetic communications.

One or more sensor devices 24 are provided. In a preferred embodiment, the sensor 24 measures the core or heat sink level temperature of the electronic board, ambient temperature, or the die temperature of the LED 20. Measuring a temperature of a known physical position that has a well-defined relationship such as the LED die temperature is preferred over simply measuring ambient temperature. In an exemplary embodiment, the sensor contains a temperature transducer, such as a thermocouple, thermistor or integrated circuit temperature sensor.

Other sensor devices can be used to measure other environmental parameters such as ambient light. The microprocessor can correlate the ambient light to a time of day (either using a clock device which is part of the microprocessor 18 or an external device 23) and use this information to modify the current value to provide energy efficient lighting in all daylight and night-time applications. The microprocessor can perform a statistical analysis on how many hours the LEDs have been overdriven and maintain the units within their expected lifetime. This will allow for LEDs to be overdriven in daylight applications and dimmed for night-time applications. Likewise, the clock device, which can be an external device 24 or part of the microprocessor 18 can measure the hours of illumination of the LEDs wherein the microprocessor or an external device can then determine the current value for the LEDs based on the overall usage of the LEDs so as to compensate for degradation.

The sensor 24 can also be a monitoring mechanism or device. The monitoring device(s) can monitor an intensity and/or color of light emitted by LED(s) such that a color rendition and/or color balance can be calibrated. If the monitoring device is internal to a fixture containing the present invention, the present invention can be self-calibrating. In another embodiment, if the monitoring device is external to the fixture, where communication may be performed through the communication device 22, the monitoring device can be used to calibrate the present invention during manufacture, service and/or maintenance.

As discussed throughout, current sensors and drivers 26 are used to determine current readings, provide current, and/or control current to the LED 20. As also discussed throughout, a feedback mechanism 28 is provided to provide current readings from the LED 20 to the microprocessor 18.

The present invention can also be used as a dynamic power management system for a point source LED that can have 3 or more colored LED sources. In such cases an LED manufacturing process typically requires that a maximum allowed current through each LED be dependent upon a total current supplied to all LED sources. The microprocessor 18 can analyze a total drive current to all LED sources where this information is provided to the microprocessor 18 through the feedback loop 28. The microprocessor 18 then commands that each individual drive current to each individual LED be modified such that a total power dissipation of the LED sources is not exceeded. This ensures that the maximum theoretical intensity for primary and secondary colors can be achieved without overdriving the fixture on near white colors.

FIG. 3 more particularly is an exemplary embodiment of the feedback mechanism 28, illustrated by the electrical schematic of a circuit for controlling current through several LEDs or LED sources in series. As illustrated, a voltage V_{c} is generated by a digital to analog converter, IC3, which may reside inside a microprocessor 18 or as an external device 23. An op-amp and transistor combination 30 converts control voltage to current through the LEDs, or LED sources, 20. R1 is used to set a maximum current. As discussed above, a software algorithm in the microprocessor 18 compares current values and compensates for when the actual and the desired current is determined. In one embodiment this successive approximation correction continuously takes place and in another embodiment it occurs occasionally where the information is stored in memory, located in either the microprocessor 18 or a remote device 23.

The present invention can also be used where multicolor LED sources 20 have an overall package dissipation factor where one LED 20 can be driven at full power but when multiple LEDs 20 are powered, the power to drive each LED is gradually derated when two and then three LEDs 20 are driven. In this embodiment, the maximum current to each LED color is set in the hardware such as but not limited to a resistor R1 or microprocessor 18, to the maximum permissible value. Control software in the microprocessor 18 then uses an algorithm that scales the overall LED intensity based on the color content of a communication signal, such as but not limited to a DMX signal.

The present invention can also use dynamic intensity calibration which is an extension of the invention disclosed above. The processor 18 continuously monitors the voltage X2. R1 is a high accuracy resistor, so the voltage at X2 provides an accurate indication of the actual LED current. A 10 bit or better analog to digital converter, which may be part of the microprocessor 18, IC3 or another external device 23, is used to achieve 8 bit, such as but not limited to DMX, accuracy. The processor contains a lookup table that details the current required for every possible DMX value, such as 256×10 bit values. In a preferred embodiment an analog drive connected to the op-amp also has a 10 bit or better accuracy. In another preferred embodiment a digital drive is utilized.

Though digital control is also possible, analog control is preferred for a number of reasons, such as but not limited to, available firmware being less complicated, there are no power issues, the printed circuit board is less complicated, and a greater array of circuits can be used. Whereas digital control typically results in having a poorer control curve at lower levels, it is more difficult to monitor voltage of an LED, there are more flicker issues (especially when used with television and film devices), it is harder to obtain the Federal Communication Commission (FCC) compliance, the resolution is limited, and fault tolerances are harder to isolate. However some benefits of digital control are that they are less expensive and less complicated to create, can be centrally located, and are less susceptible to power issues.

A process of successive approximation is then used wherein when the DMX value changes, X1 is initially set to a voltage corresponding to the requested DMX value. X2 is then checked to see whether it is higher or lower than the value in the lookup table. If it is lower, then the value of X1 is incremented. If the value is higher, then the value of X2 is decremented. To ensure proper operation, it is necessary for the analog to digital converter (ADC) and the digital to analog converter (DAC) to be better than the DMX signal resolution in order to prevent feedback loop hunting. The DAC and/or ADC could be internal to the processor 18 or an external element. In another embodiment, the DAC produces a constant pulse width modulation signal integrated to analog.

In the present invention, the processor 18 can also be used to keep count of the number of hours that each LED 20 is on. The intensity of an LED 20 degrades over time and manufacturers typically publish a graph illustrating the degrade rate over time. Thus the processor 18 could boost the current driven to the LED 20 on an incremental basis, such as a higher rate once per month. By doing so, the visual effect of light degradation would be minimized.

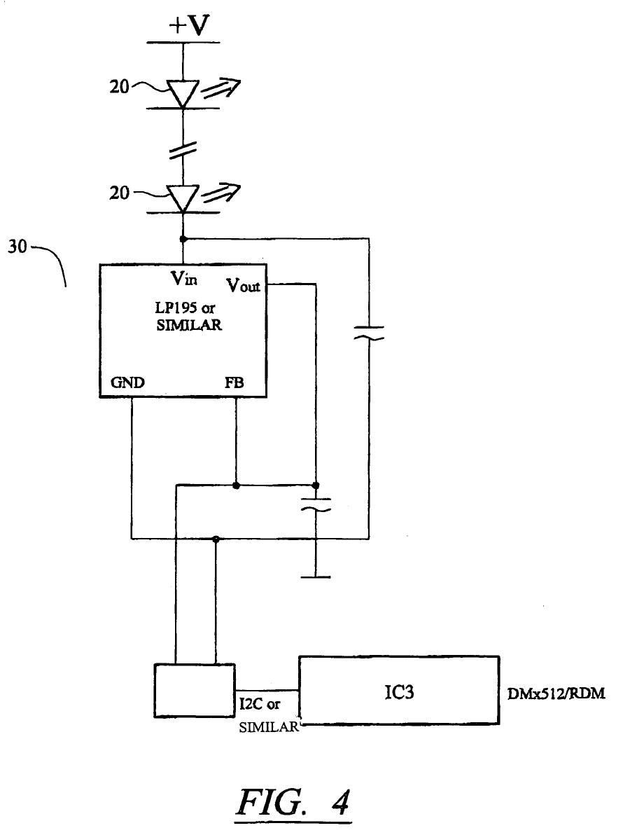

In a preferred embodiment, illustrated in FIG. 4, a standard micro power voltage regulator 32, such as but not limited to an LP1951, is used to produce an analog current control. Current through the LEDs is set by a resistor IC5. This resistor can be, but is not limited to being, a digital potentiometer that is set by a microprocessor 18 (IC6). The use of a logarithmic digital potentiometer is also a good selection since current value can be increased over the lower current ranges, which is useful when generating color tones. ICS can be combined with a resistor that sets the maximum current. If a digital potentiometer of higher resolution is used, current values can be selected from a lookup table. In this case, user defined response curves and correction for eye response or even matching different manufacturer's LEDs is possible.

The present invention can also be used to balance the color white to make sure that multiple fixtures when illuminated in white mode will have the same color temperature. As previously discussed, as LEDs degrade, manufacturer's data sheets usually provide a graph as to how degradation occurs over time. These graphs are different based on the color of the LED and the manufacturer. Using information from the data sheets, data is supplied to the processor 18 so that the microprocessor can vary current to result in retaining color balance by varying intensity over the life of the LEDs 20.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

What is claimed is:

1. A method of accurately controlling at least one of an intensity, brightness, dimming or color mixing of an LED, said method comprising:
a) monitoring an actual current flowing through the LED;
b) selecting a specific current based on at least one of a desired illumination intensity, a desired brightness, a desired dimming, or a desired color mixing;
c) comparing said actual current and said specific current; and
d) if a difference exists between said actual current and said specific current, adjusting said actual current to agree with said specific current.

2. The method of claim 1 wherein the step of monitoring comprises measuring a voltage across a sensing resister connected to the LED and the step of comparing comprises providing the voltage to a processor by way of a feedback loop mechanism wherein the voltage is converted to current.

3. The method of claim 1 further comprising controlling an amount of current flowing through the LED with a semiconductor device.

4. The method of claim 1 wherein the step of monitoring comprises measuring a voltage across the LED by using a current sensing resister and then determining the current by using an electronic feedback loop to calculate the actual current.

5. The method of claim 1 wherein the step of adjusting further comprises adjusting using at least one of a digital control device and an analog control device.

6. The method of claim 1 wherein said method operates autonomously.

7. The method of claim 1 wherein the step of adjusting said actual current further comprises selecting and addressing said specific current value with an addressable external device.

8. A light emitting diode system for controlling at least one of an intensity, brightness, dimming or color mixing of an LED, said system comprising a control system including a microprocessor arranged to control a current value of said LED by comparing an actual current value with a desired current value and establishing a new actual current value.

9. The system of claim 8 further comprising a current feedback mechanism to monitor said actual current value of said LED.

10. The system of claim 9 wherein said feedback device comprises at least one of a current sensing integrated circuit or a discrete electrical circuit.

11. The system of claim 8 further comprising a sensing device to determine at least one of ambient temperature, temperature at a heat sink level of said system, die temperature of said LED, or ambient light around said system.

12. The system of claim 11 wherein data collected by said sensing device is communicated to an external device which provides an external control on said system.

13. The system of claim 8 further comprising a communication device providing a data connection interface to at least one of an internal device or an external device.

14. The system of claim 8 wherein said system eliminates a flicker effect due to beating effects between a LED modulation frequency and at least one of a film or video frame rate.

15. The system of claim 8 further comprising a monitoring device for determining at least one of an intensity or color of light emitted by said LED such that at least one of a color rendition or color balance is calibrated.

16. The system of claim 15 wherein said system is self-calibrating.

17. The system of claim 8 wherein said system controls a plurality of LED sources wherein different wavelength bands are used by a different number of LED sources within said plurality of LED sources.

18. The system of claim 8 wherein said control system is at least one of an analog control system and a digital control system.

19. The system of claim 8 further comprising an external device that provides control inputs by communicating between itself and said microprocessor.

20. The system of claim 19 further comprising a time clock device, which is at least one of part of said external device or said microprocessor, to measure a time of illumination of said LED wherein said actual current value for said LED is established based on compensating for a pre-determined degradation rate of said LED.

21. A dynamic power management system for a point source LED having three or more colored LED sources wherein a LED manufacturing process requires that a maximum allowed current through each LED be dependent upon a total current supplied to all LED sources, said system comprises a microprocessor to analyze a total drive current to all LED sources wherein this information is used to modify drive current to each individual LED such that a total power dissipation of the LED sources is not exceeded.
